(19) United States
(12) Patent Application Publication
(10) Pub. No.: US 2016/0183480 A1
(43) Pub. Date: Jun. 30, 2016

(54) Invention to Interrupt, Dissolve or Destroy a Tornado

(71) Applicant: Pastor Perafan Homen, Bogota (CO)

(72) Inventor: Pastor Perafan Homen, Bogota (CO)

(21) Appl. No.: 14/544,349

(22) Filed: Dec. 29, 2014

(51) Int. Cl. A01G 15/00; B64C 39/02; G01W 1/00

(52) U.S. Cl. CPC A01G 15/00; G01W 1/00; B64C 39/024; B64C 39/02; B64C 2201/128

(57) ABSTRACT

The function of this invention is to build a Tornadoes' Destroyer Center to dissolve, or to destroy the tornadoes during their formation stage, or during their projection toward the earth, before they reach the earth and before they start their destructive and violent whirling movements. The technology to use will be the commercial fumigation aircraft, the drones (non-piloted aircrafts), or any type of piloted, or non-piloted aircraft, equipped or adapted to in form of spray, to launch “strong streams of hot water,” or, if it would be necessary, these above mentioned aircrafts could be adapted to launch streams of extinguishment substances. The above mentioned specially equipped aircrafts will launch strong streams of hot water, or streams of extinguishment substances against the weakest point where be possible to reach the projection's cone of a detected tornado. Once the above mentioned strong streams of hot water, or streams of extinguishment substances, reach and permeate the projection's cone of a tornado, it instantaneously will be dissolved, or destroyed. Therefore, this tornado will not cause damages on the earth, because through this effective system, during the tornado's projection toward the earth they will be fully eliminated.

### CROSS-REFERENCE TO RELATED APPLICATIONS

Provisional Patent Application No. 61/920,766; Dated: Dec. 25, 2013.

### STATEMENT REGARDING FEDERALLY SPONSORED RESEARCH OF DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Concerning a prior art, of how to dissolve or destroy a tornado with the same methodology of the current invention, there is not any registered record, except my “Provisional Patent Application” above mentioned, which was filed on Dec. 25, 2013. The researchers are currently hard at work devising ways to control the weather, particularly disastrous weather systems like tornadoes and hurricanes, and hope to put their ideas to test in the comming decades, but currently they are still at extreme hypothetical stage.

The technology that will be used in the current invention of how to dissolve or destroy the tornadoes, is fully experimented. The strategy and technics are simple to apply. Therefore, it is very easy to conclude and to find the effectiveness of this needful invention. The first liquid substance selected to carry out this invention is natural “hot water,” which will not cause any potential environment damage. If it would be necessary to use any type of extinguishment substances, these substances should be carefully selected, taking into account that they be no harmful, nor noxious to the plants, humane life, nor the animal life. In general terms, these substances should not be harmful for nothing that have to see with the natural environment.

According to the U.S. National Climate Data Center, due to the violent tornadoes, yearly, the United States loses hundreds of humane lives, and to attend their damages, spend billions of dollars. Therefore, the settling of a Tornadoes Destroyer Center to apply this effective invention to dissolve or destroy the tornadoes' natural phenomenon, is an invaluable solution against the above mentioned humane and economic destruction, that yearly the violent tornadoes make to the United States and the other countries in the world.

### BRIEF SUMMARY OF THE INVENTION

The substance of the current invention is to interrupt, dissolve or destroy the tornadoes at their “starting's point,” when they are in their weakest stage, or during their projection toward the earth, before they reach it, and before they start their violent and destructive performing's stage.

As in the detailed description is disclosed, the method to achieve this great goal is very simple, but 100% effective, and its principle advantage is that the substances that will be used are not harmful for the natural environment.

### BRIEF DESCRIPTION OF THE SEVERAL VIEWS OF THE DRAWINGS

The drawing of this invention contains seven pages of drawn views which, in an easy way, let us see and comprehend the principle steps, strategies, and techniques of how this invention works, as follows:

Page 1, contains the FIG. 1, which illustrates a general view of how would be a Tornadoes' Destroyer Center's facility with communication antennas, a runway, aircrafts, and a hangar.

FIG. 1A, illustrates an external general view of what would be the well equipped facility that has to have each runway assigned to what will be the Tornadoes' Destroyer Center (Ts'.D.C.), where the pilots efficiently will receive information about the appearing or configuration of tornadoes and hence, the opportune order to destroy them, as well as, in this facility, the pilots and the other workers that be necessary to use, would have foodstuff, and some rooms where they could sleep and rest.

FIG. 1B, illustrates a general view of what would be a hangar of a Ts'.D.C. with its aircrafts, and a runway.

FIG. 1C, illustrates a general view of what would be the aircrafts of a Ts'.D.C. in their hangar.

FIG. 1D, illustrates a general view of what would be a Tornadoes' Destroyer Center's runway with aircrafts' movement.

FIG. 1E, illustrates a general view of what would be the weather information system of the TS'.D.C.

Page 2, contains the FIG. 2, which illustrates a general view of how is a tornado in its first configuration stage, where appears a cumulonimbus, or supercell, with the “starting point” of the first configuration of the projection's cone of a tornado directed toward earth. Also, at the lower plane appear a tranquil country house, which would be exposed to what could be this future tornado.

FIG. 2A, illustrates a general view of what in this invention is named as the “starting point” of the first configuration of the projections' cone, or funnel, of a tornado.

FIG. 2B, illustrates a general view of a supercell, where generally the tornadoes start.

FIG. 2C, shows a general view of a tranquil country house, which would be exposed to what could be this future violent tornado.

Page 3, contains the FIG. 3, which illustrates a general view and destructive performing's stage, where appears that the projection's cone, or the “funnel” of a tornado has reached the earth, and with its violent winds and whirling movements is thoroughly destroying a country house.

FIG. 2B, illustrates a general view of the supercell that is supporting and complementing the energy of this violent tornado.

FIG. 3A, illustrates a general view, where appears that the projection's cone, or funnel of this tornado, has reached the earth.

FIG. 3B, illustrates a general view where this tornado with its violent winds and whirling movements is thoroughly destroying a country house.

Page 4, contains the FIG. 4, which illustrates a general view of how is a tornado in its weaker stage. Also, this view shows a general view of what would be an aircraft of the Tornadoes' Destroyer Center (Ts'.D.C.), launching strong streams of hot water, against the “starting point” of this future violent and destructive tornado. As well as, this view shows a runway and an airplane when it had taken off and turned toward the “starting point” of the above mentioned tornado, when it is in its weaker stage.

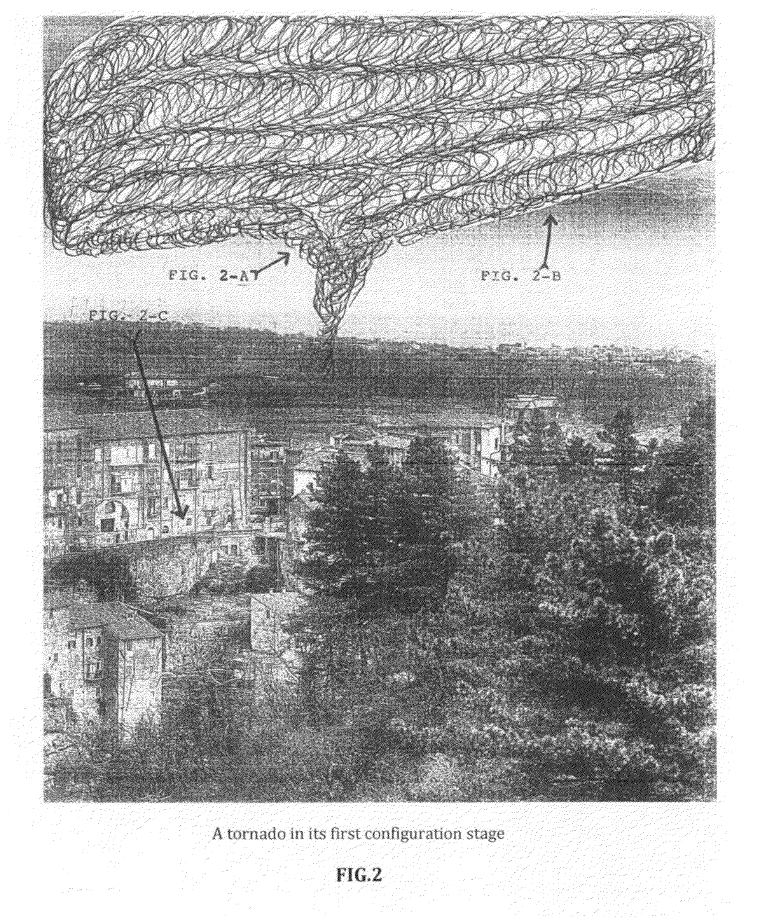

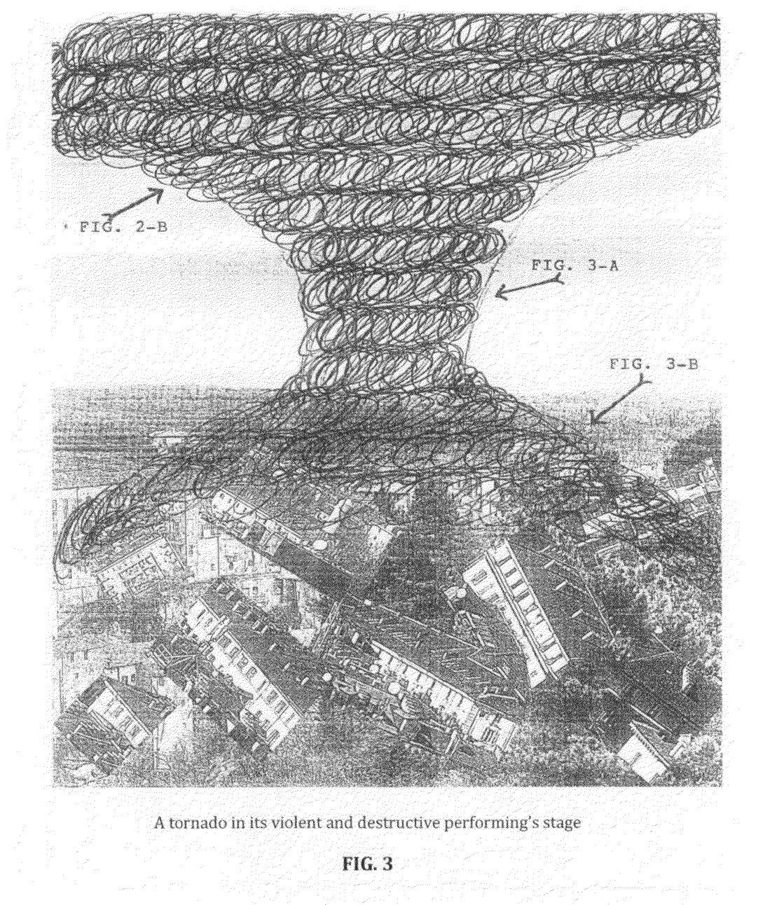

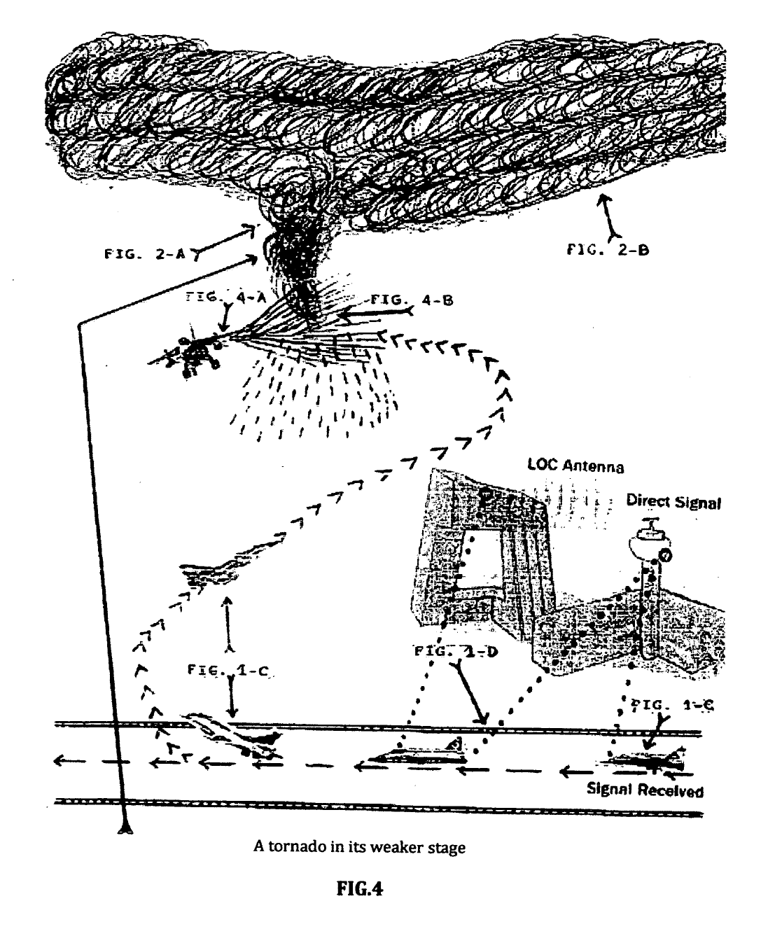

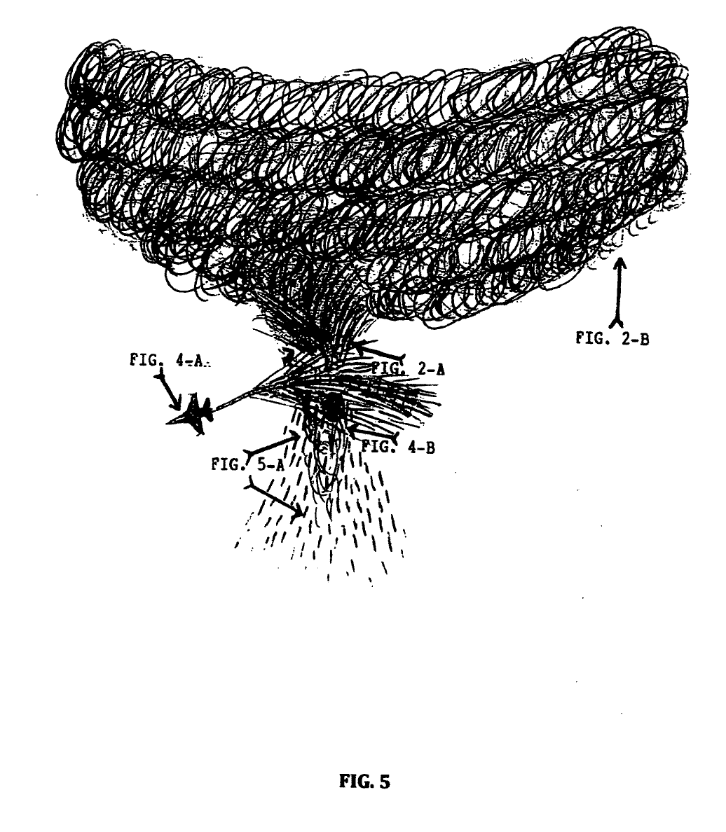

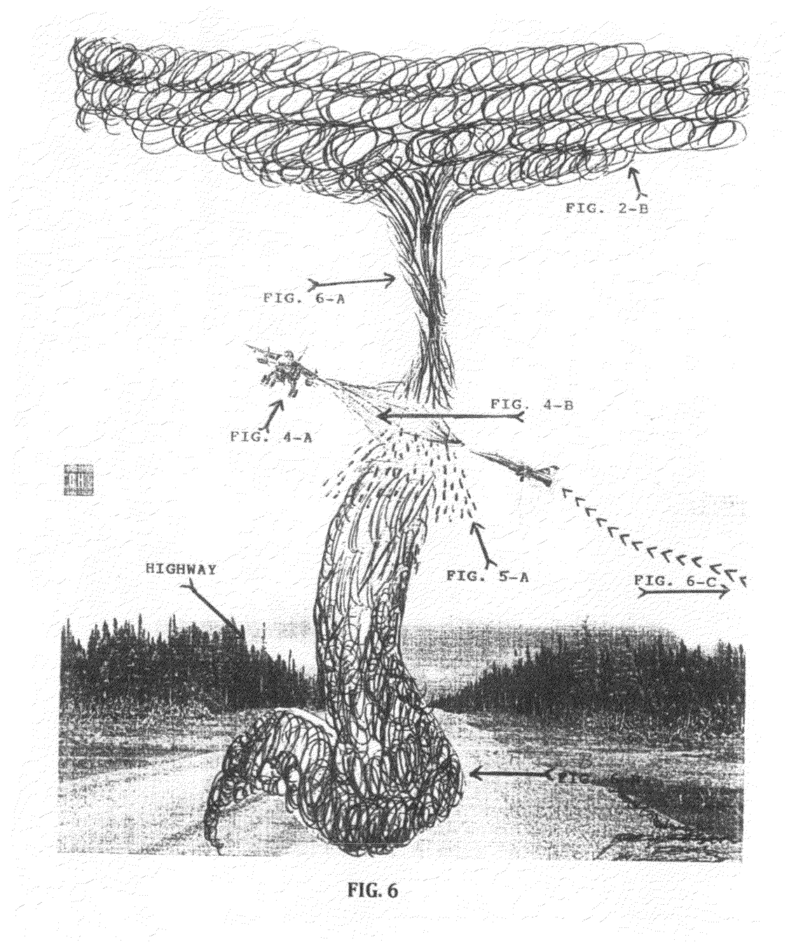

FIG. 2A, illustrates a general view of the “starting point” of this tornado.

FIG. 2B, illustrates a general view of the supercell, from where this tornado is appearing.

FIG. 4A. illustrates an aircraft of the Ts'.D.C. launching strong streams of hot water against the “starting point” of this future violent and destructive tornado.

FIG. 4B, illustrates a general view of the strong streams of hot water launched by the Ts'.D.C. aircraft, which are permeating the starting point of this tornado, and hence it will be destroyed at the beginning of its configuration.

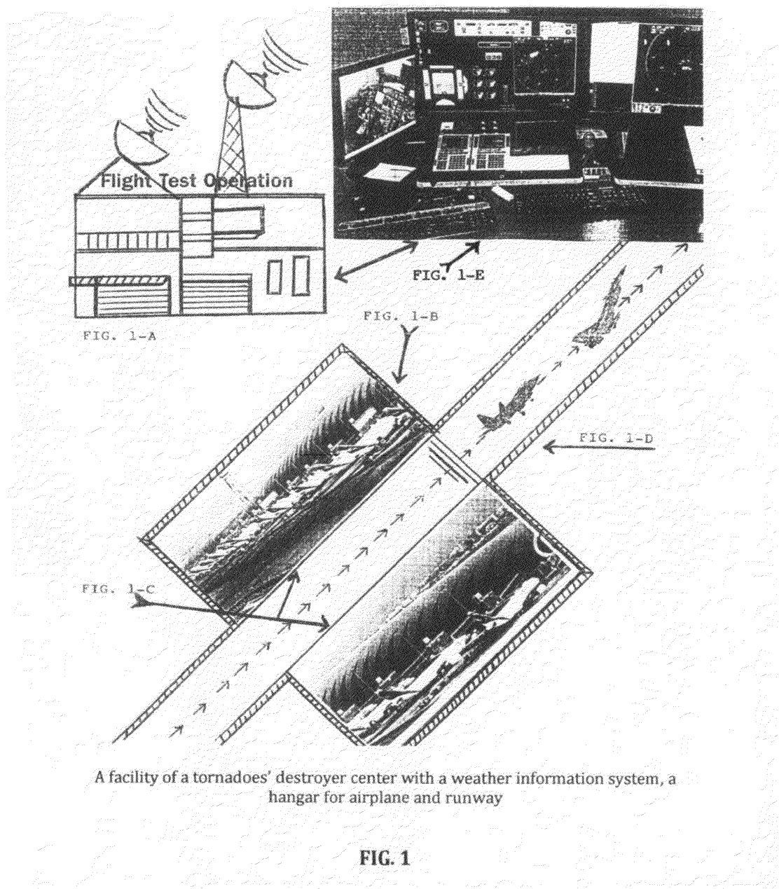

FIG. 1C, illustrates a general view of an aircraft of the Ts'.D.C. when it is moving in the direction toward the starting point of this tornado.

FIG. 1D, illustrates a general view of what would be a runway of the Ts'.D.C.

Page 5, contains the FIG. 5, which illustrates a general view of a cumulonimbus, or supercell, where appears that an airplane, or drone, of what will be the Ts'.D.C., has dissolved, or destroyed a tornado at its first configuration stage. The view shows that the hot water launched by the airplane has permeated the first configuration's cone of a tornado, and therefore has dissolved, or destroyed the starting point of the projection's cone of what very soon could be a violent and destructive tornado.

FIG. 2A, illustrates the starting point, or first configuration of this tornado.

FIG. 2B, illustrates the supercell, from where this tornado is appearing.

FIG. 4A, illustrates an aircraft, or drone, of the Ts'.D.C. launching strong streams of hot water against the starting point, or first configuration of this tornado.

FIG. 4B, illustrates the strong streams of hot water launched by the aircraft of the Ts'.D.C.

FIG. 5A, illustrates a general view of the “starting point,” or first configuration of this tornado being destroyed or dissolved, and converted in just a rain.

Page 6, contains the FIG. 6, which illustrates a general view of what would be an aircraft, or drone of the future Ts'.D.C., destroying or dissolving a tornado when it has touched down. The view shows that the hot water launched by the Ts'.D.C. aircraft has permeated the funnel, or the projection's cone of the tornado, and therefore, appears that this tornado is being interrupted, or dissolved, before it starts a violent destruction on the ground.

FIG. 2B, illustrates a general view of the supercell from where this tornado emerged.

FIG. 4A, illustrates a general view of what would be an aircraft of the Ts'.D.C. launching hot water against the funnel of this tornado.

FIG. 4B, illustrates a general view of the strong streams of hot water launched by the aircraft of the Ts'.D.C. against the funnel of this tornado.

FIG. 5A, illustrates a general view, indicating that the strong streams of hot water launched by the aircraft of the Ts'.D.C. strongly have penetrated and permeated the funnel of this tornado, and therefore one portion of the funnel is converted in a rain, and its lower part has been disconnected from the supercell.

FIG. 6A, illustrates a general view of the funnel of this tornado.

FIG. 6B, illustrates the touched down of this tornado.

FIG. 6C, illustrates the possible movement route of the aircraft that appears launching hot water against the funnel of this tornado.

Page 7, contains the FIG. 7, which illustrates a general view of what would be several aircrafts, or drones, of the future Ts'.D.C., launching hot water against the projection's cone, or “funnel” of a tornado. The view shows that the hot water launched by three aircrafts of the future Ts'.D.C. have fully permeated the projection's cone, or “funnel” of this tornado, and therefore, its connection with the supercell is thoroughly dissolved, or destroyed. Hence, this violent tornado will disappear, and the earth with its containment, including us the human beings, will be free of what would be the violent destruction, because this tornado. Wow!!!

FIG. 2B, illustrates a general view of the supercell from where this tornado emerged.

FIG. 4A, illustrates a general view of what will be three aircrafts, or drones of the Ts'.D.C., launching strong streams of hot water against the funnel of this tornado.

FIG. 4B, illustrates a general view of what will be the strong streams of hot water launched by three aircrafts, or drones, of the future Ts'.D.C.

FIG. 5A. illustrates a general view indicating that the strong streams of hot water launched by three aircrafts of the Ts'.D.C. have penetrated and permeated a great portion of the funnel of this tornado; now it have been interrupted, and converted in just rain. Wow!!!

FIG. 6B, illustrates a general view of the touched down of this tornado.

FIG. 6C, illustrates a general view of the possible movement route of the aircrafts of the Ts'.D.C. that appear launching hot water against the funnel of this tornado.

### DETAILED DESCRIPTION OF THE INVENTION

As illustrated in FIGS. 2, 2A, 2B, and 2C, in general and simple terms, a tornado starts its formation in a cumulonimbus, or in a supercell, beginning with a little cone of cloud, which continues increasing in width, size and length projection toward earth.

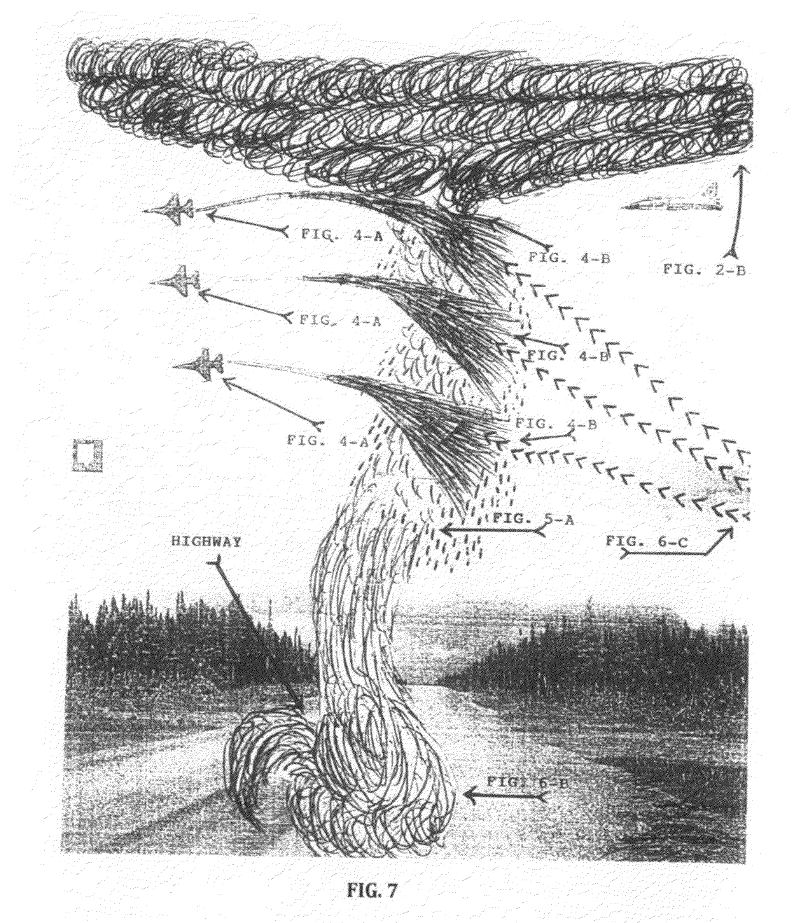

As illustrated in FIGS. 3, 2B, 3A, and 3B, once a tornado has reached the earth, it starts its destructive and violent whirling movements.

The best way to destroy or oppose to any artificial or natural structure, is looking for its weakest starting's point. Therefore I, Pastor Perafan Homen, the “inventor” of the current project, through the observation's process, created the theories about the weakest starting's point of the tornadoes, and the appropriate moment in which the tornadoes are weaker.

Also, when we are planning to destroy any artificial or natural structure, we need to find out what material that structure is made of. In this case, the first structure of a tornado is made of a visible mass of water's particles. The conjoint of these particles are widely known as a cloud. The particles of this cloud are under intense cold temperature.

Therefore, as illustrated in FIGS. 5, 2B, 2A, 4A, 4B, and 5B, it is easy to come to the conclusion, that if against the above mentioned cold cloud, we launch particles of condensed hot water, the cloud will be dissolved. That means, that according to this beautiful project, the cloud that on a cumulonimbus, or supercell, in form of a little cone appears to conform the “starting's point” of a tornado will be dissolved, or destroyed, at the beginning of its cone's configuration.

If the initial configuration's cone of a tornado is dissolved or destroyed, this tornado could not continue its projection toward earth. This tornado will disappear, and the earth will be free of its usual destructive and violent whirling movements.

Based on the above mentioned theories, the strategies and techniques were created to dissolve, or destroy the initial formation of the projection's cone of the tornadoes, when they are at their “weakest starting's point,” or during their projection toward the earth at the weakest point where be possible reach them.

Making use of the beautiful and advanced today's technology, in order to achieve the above mentioned goals against the violent and destructive tornadoes, it is required to use the adaptation of the equipments that in the current market are available as the piloted, and non-piloted aircrafts. Also, it is required the use of a natural substance (hot water), or instead of we could possible use some of the chemical substances available in the simple, or specialized market.

### Determination of the Weakest Starting's Point of a Tornado:

As illustrated in FIGS. 2, 2A, 2B, and 2C, the “weakest starting's point” of a tornado is the initial cumulous of cloud that in a cumulonimbus, or a supercell, in the form of a little cone, its formation begins. Also, as it is understandable, that is the stage in which a tornado is weaker.

Available Information about the Appearing of Tornadoes:

As illustrated in FIG. 1E, the equipments of today's technology are giving us, actual and opportune information about where, and when a tornado, or some tornadoes would be appearing. Also, we are obtaining information about in what region some tornadoes threat appear.

### Equipment's Adaptation:

The selected equipments that will be adapted for the above mentioned goals against the violent and destructive tornadoes, are: (a) the commercial fumigation aircraft, (b) the drones (non-piloted aircraft), and (c) any type of aircraft piloted or non-piloted, available to be adapted as is explained hereafter.

The above mentioned commercial fumigation aircrafts, and drones, should be adapted to in the form of a spray, to launch strong streams of hot water (for this project, this system is going to be called “Hot Water's Launcher”). Also, if it would be necessary, some of the above mentioned air-machines, could be adapted to launch streams of Liquid Extinguishment Substances (for this project, this system is going to be called: Liquid Extinguishment Substances' Launcher). If it is not possible to adapt a system through which the above mentioned airplanes are able to launch ahead the hot water, or the liquid extinguishment substances, then the airplanes will be adapted to launch the hot water, or the liquid extinguishment substances, by back or by underneath, as the fumigation planes do it.

### Substances That Could be Used in the Current Invention:

(a) Hot water,
(b) Liquid extinguishment substances.

### Strategies to Destroy the Tornadoes Before They are Projected Toward Earth:

As illustrated in FIGS. 5, 2A, 2B, 4A, 4B, and 5A, through the techniques further in the current invention established, the tornadoes will be dissolved, or destroyed, at their above mentioned “starting's point,” when they are weaker or during their projection toward the earth at their weakest point of their funnel where be possible reach them. Their funnel, or projection's cone, toward earth will be dissolved, or destroyed; therefore, the tornadoes will not reach the earth. Hence, with this beautiful invent, the earth and all its contents, including we the human beings, will be free of the violent and destructive tornadoes.

General Steps and Techniques to Destroy, or Dissolve a Tornado at its Starting's Point, When it Begins to Build its Projection's Cone Toward the earth, or During its Projection Toward the Earth at its Weakest Point of its Funnel Where be Possible Reach it:

### General Steps:

(a) As illustrated in FIGS. 1, 1A, 1B, 1C, 1D, and 1E, once the above mentioned commercial fumigation aircrafts, and drones, have been properly adapted to launch strong streams of hot water, or liquid extinguishment substances (what after a due experiment, be better applicable), these air-machines, and all that be necessary to operate them, should be settled in the predominant and potential places of the earth, where during the storms, the tornadoes can be, or could appear.

(b) As illustrated in FIGS. 1B, 1C, and 1D, if close to these predominant and potential places where the tornadoes could appear, there is not a runway, we need to build up enough runways needed for to land, to stand by getting ready, and take off the aircrafts that will be used in this wonderful project.

(c) Skilled pilots should be appointed to operate the above mentioned specially equipped aircrafts.

(d) The current communication system about the appearing of tornadoes, should be efficiently implemented for this wonderful project.

### Techniques to Destroy or Dissolve a Tornado at its Starting's Point, by Destroying or Dissolving the Building of its Projection's Cone Toward Earth, or by Destroying its Funnel During its Projection, or Movement Toward the Earth:

(1) Verification's Period: Once the equipment's installation and people have been appropriately assembled, we need to use a period of time for “verification.” During this time, we will verify the effectiveness of all the equipments, and the skills of the people that will be used in this beautiful project. If corrections would be needed they carefully should be made.

(2) Time's Calculation: During this time we will calculate:
(a) The space of time, that a tornado remains in its weaker starting's point;”
(b) The space of time, in which the future “violent tornado” appears and remains as a little cone of cloud;
(c) The approximated time, that our specifically adapted aircrafts will spend to approach to the point where in any indicated place of a cumulonimbus, or supercell, a tornado would be appearing;
(d) The approximate time that a tornado's cone projection spends from its beginning until to reach the earth.

### Calculation of the “Distance's Effective Range:”

In order to make this calculation we will take into account the distance's range that the streams of hot water, or liquid extinguishment substances, effectively reach when from our airplanes, through their Hot Water's Launcher, or Liquid Extinguishment Substances' Launcher, are launched.

Once the verification's period and the time's calculation successfully has been completed, we are ready to dissolve, or destroy the tornadoes before they become violent, and destructive.

### General Proceedings:

(1) In order to manage and achieve the goals contained in this helpful project, which urgently the world is needing, principally the United States, a government institution, or a private corporation should be created. Therefore, by advance, I suggest the “P.P.H. TORNADOES' DESTROYER CENTER” (P.P.H. represents the inventor's name “Pastor Perafan Homen”).

(2) Yearly, before the tornado season starts, the Tornadoes' Destroyer Center (“Ts'.D.C.”) will be ready to destroy or dissolve them, when they still would be at their weaker starting point, or during their projection toward the earth, before they reach it, and before they start their violent whirling movements. Enough aircrafts, and pilots have to have the runways assigned to the Ts'.D.C. As previously in this project was established, the aircrafts and drones have to be adapted and equipped to launch strong streams of hot water, or liquid extinguishment substances.

(3) As illustrated in FIGS. 1, 1A, 1B, 1C, 1D, and 1E, each runway assigned to the Ts'.D.C. has to have a well equipped facility, where the pilots efficiently will receive information about the tornadoes; as well as, in this facility, the pilots and the other workers that will be necessary to use, could have foodstuff, and some rooms where they could sleep and rest.

### Proceeding to Destroy or Dissolve the Initial Projection's Cone of a Tornado at its Starting's Point, or Destroy the Tornado's Funnel During its Projection Toward the Earth:

Once the Ts'.D.C. sees the initial “Projection's Cone” of a tornado, or the funnel, as fast as is possible it will make the required verifications. Simultaneously, during this verification the pilots have to take position in their airplanes, and through their communication system follow the verification proceeding.

If the verification proceeding shows a positive projection's cone of a tornado, or its funnel in movement toward the earth, right away one pilot, or the required number of pilots, will receive the order to destroy, or dissolve the “starting's point,” or the funnel of the referenced tornado.

As illustrated in FIGS. 4, 1C, 1D, 4A, 2A, and 2B, the airplane, or airplanes, right away will take off and turn on in direction of the “starting's point,” or in the direction of the funnel, of the referenced tornado. As soon as the airplane, or airplanes, reach the above mentioned “distance's effective range,” the pilots will aim to the “starting's point” of the “projection's cone,” or the funnel, of the concerned tornado, and will turn on the “Hot Water's Launcher,” or the “Liquid Extinguishment Substances' Launcher,” (L.E.S.L.).

As illustrated in FIGS. 6, 6A, 4A, 4B, 5A, and 6C, by turning on one of these systems the airplane will launch strong streams of hot water, or liquid extinguishment substances, against the “starting's point” of the projection's cone, or against the funnel, of this tornado. As soon as the strong streams of hot water, or liquid extinguishment substances, reach and permeates the “starting's point,” or the funnel of this tornado, its projection's cone, or funnel, toward the earth will be dissolved, or destroyed, the potential violent and destructive tornado will disappear, and therefore, by using this beautiful and helpful invent, our plant earth and all its content, including us the human beings, will be free of the violent and destructive tornadoes. WOW!!!

### Important Notice:

As illustrated in FIGS. 6, 7, 4A, 4B, 5A, and 6C, if the Ts'.D.C. dissolves or destroys the funnel, or projection's cone of a tornado at a certain point of its projection and still remains a piece of its funnel connected to the supercell, then the Ts'.D.C. aircrafts right away have to continue launching hot water, or extinguishment substances against the remaining piece of funnel until it is totally destroyed and disconnected from its supercell; avoiding like that, that the remaining piece of funnel rebuild its projection's cone toward earth.

1. A method of assembling a Tornadoes Destroyer Center's facility equipped with the required employees, including expert aircraft pilots, a weather and tornadoes information system, a hangar, a runway, aircrafts and drones which should be specially adapted to launch strong streams of hot water, streams of extinguished substances, or streams of dissolver substances.

2. A method of looking for the weakest starting point of the projection's cone of the tornadoes, and the appropriated moment in which the tornadoes are weaker, whose facts happen on the edge of the cumulonimbus, or “supercell,” when a tornado is in its first configuration stage.

3. A method of interrupting, dissolving, or destroying a tornado in its weakest starting's point, consisting of the steps of: using the specially adapted aircrafts and drones, above mentioned in the claim 1, which against the starting's point of the tornado will launch strong streams of hot water. Once the hot water reaches, and permeates the projection's cone, or “funnel” of a tornado in its starting's point, it will be dissolved, or destroyed, and therefore what would be a violent tornado, will be interrupted, dissolved, or destroyed at its first configuration stage.

4. A method of interrupting a tornado by dissolving or destroying its projection's cone, or “funnel,” in any point of its projection toward earth, using the method of Claim No. 3, wherein a specially adapted aircraft, or a drone, of the Tornadoes Destroyer Center, mentioned in Claim No. 1, will launch strong streams of hot water against any point of the projection's cone, or “funnel” of the tornado. Once the hot water reaches and permeates any point of the funnel of a tornado, a portion of its funnel will be dissolved, and therefore the touchdown, and the violent performance of this tornado will be interrupted because it has been disconnected from its supercell's energetic power.

5. A method of interrupting, dissolving, or destroying a tornado by dissolving or destroying its projection's cone, or “funnel,” in several consecutive points, using the method of Claim No. 3, wherein several specially adapted aircrafts, or drones of the Tornadoes Destroyer Center, above mentioned in Claim No. 1, will launch strong streams of hot water against several points of the projection's cone, or “funnel” of a tornado, including its “starting's point,” which is its connection with the supercell—therefore, the projection's cone, or “funnel,” of this tornado will be fully destroyed, and unconnected from its supercell; hence, this tornado, thoroughly, will disappear and finally the earth and its contents, including us the human beings, will be free of what would be its violent destruction. Wow!!!

6. In each of the five (5) claims above mentioned, if it would be necessary, instead of hot water, we could use any type of dissolvers, or extinguishment substances; but this substance should be carefully selected, taking into account that they be not harmful to the nature extructure, plants, human life, nor the animal life.
